(19) United States
(12) Patent Application Publication
(10) Pub. No.: US 2006/0268566 A1
(43) Pub. Date: Nov. 30, 2006

(54) Light receiving module

(75) Inventors: Morio Wada, Tokyo (JP); Toshimasa Umezawa, Tokyo (JP); Takahiro Kudo, Tokyo (JP); Takashi Mogi, Tokyo (JP); Kenji Kusumoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION

(21) Appl. No.: 11/430,246

(22) Filed: May 9, 2006

(30) Foreign Application Priority Data
May 17, 2005 (JP) P. 2005-144624

(51) Int. Cl. F21V 7/04

(52) U.S. Cl. 362/554

(57) ABSTRACT

A light receiving module for receiving a plurality of light rays that includes a first optical element having a plurality of light emitting sections, a second optical element having a plurality of light receiving sections, and a gradient index lens which condenses a plurality of light rays being output from the plurality of light emitting sections to the plurality of light receiving sections respectively, the gradient index lens being disposed between the first optical element and the second optical element.

This application claims foreign priority based on Japanese Patent application No. 2005-144624, filed May 17, 2005, the content of which is incorporated herein by reference in its entirety.

### BACKGROUND OF THE INVENTION

1. Field of the Invention

The present invention relates to a light receiving module that employs a plurality of light receiving elements or the like to receive a plurality of input light rays from a plurality of optical fibers or the like, and relates particularly to a small light receiving module that can be easily assembled.

2. Description of the Related Art

The following examples are relevant to a related light receiving module that employs a light receiving element to receive light being input from optical fibers. The examples are JP-A-06-021485, JP-A-08-159869, JP-A-09-258061, “RZ-DPSK Transmission Using a 42.7-Gb/s Integrated Balanced Optical Front End With Record Sensitivity”, Jeffrey H. Sinsky, Andrew Adamiecki, Alan Gnauck, Charles A. Burrus, Jr., Juerg Luerg Leuthold, Oliver Wohlgemuth, S. Chandrasekhar, AndreasUmbach, Journal of Lightwave Technology, pp. 180-185, Vol. 22, No. 1, 2004, and “Essentials Of The System Design And Application Of Micro Optical System For Optical Communication”, Kouichi Nishizawa, Electronics Essentials No. 11, Japan Industry Engineering Center, pp. 13-36, 1985.

A light receiving module that employs a plurality of light receiving elements to receive a plurality of rays of light input by a plurality of optical fibers can be provided, for example, by assembling optical fibers, lenses and light receiving elements, as described in “RZ-DPSK Transmission Using a 42.7-Gb/s Integrated Balanced Optical Front End With Record Sensitivity”, Jeffrey H. Sinsky, Andrew Adamiecki, Alan Gnauck, Charles A. Burrus, Jr., Juerg Luerg Leuthold, Oliver Wohlgemuth, S. Chandrasekhar, Andreas Umbach, Journal of Lightwave Technology, pp. 180-185, Vol. 22, No. 1, 2004.

According to this arrangement, however, the number of components is increased, the assembly process is complicated, and reducing the size of the module is difficult.

FIG. 3 is a cross-sectional view of an example of a related light receiving module which deals with such a problem. In FIG. 3, the light receiving module includes: an optical fiber 1, which is either a plurality of optical fibers or a multicore optical fiber; a spherical or aspherical lens 2; a light receiving device 3, which includes a plurality of light receiving elements; and a package 4 to which the optical fiber 1 is to be fixed and in which the lens 2, the light receiving device 3, or the like are to be mounted.

One end of the optical fiber 1 is fixed to the package 4, and the lens 2 and the light receiving device 3 are fixed inside the package 4. A plurality of rays of light output from one end of the optical fiber 1 is passed through the lens 2, and is condensed by the plurality of light receiving elements constituting the light receiving device 3.

As a result, an optical system is constituted that condenses a plurality of rays of light input by the optical fibers 1 to a plurality of light receiving elements by employing only a single spherical or aspherical lens, thus the number of componens can be reduced.

FIG. 4 is a cross-sectional view of another example of the related light receiving module. In FIG. 4, the light receiving module includes: an optical fiber 5, which is either a plurality of optical fibers or a multicore optical fiber; spherical or aspherical lenses 6 and 7; a light receiving device 8, which includes a plurality of light receiving elements; a package 9 to which the optical fiber 5 is to be fixed and in which the lenses 6 and 7 are to be mounted; a hermetic package 10, which is a sealed, airtight container wherein the light receiving device 8 is mounted; and a glass window 11, used to provide and maintain an airtight seal for the hermetic package 10 and to introduce the light being output.

One end of the optical fiber 5 is fixed to the package 9, the lenses 6 and 7 are mounted inside the package 9, and the light receiving device 8 is fixed inside the hermetic package 10.

A plurality of rays of light, output at one end of the optical fiber 5, passes through the lens 6, and exits as parallel rays of light that are condensed by the lens 7. Then, the condensed lights pass through the glass window 11 and are respectively collected by the plurality of light receiving elements constituting the light receiving device 8.

Since the optical system is constituted so that a plurality of rays of light output by the optical fiber 5 is condensed to a plurality of light receiving elements by employing two spherical or aspherical lenses, the number of components can be reduced.

Further, a method, such as one that employs a butt-joint to connect optical fibers directly to light receiving elements, may be used to couple the light receiving elements with the optical fibers. Further, when employed for a copier, a facsimile machine or a printer, a gradient index lens array can be used to condense a plurality of rays of light to be output to a plurality of light receiving elements.

According to the related example shown in FIG. 3, however, the optical system employs a single lens 2, so that the distance from the lens 2 to the light receiving device 3 may not be satisfactory because it is too short. This distance, for example, may be equal to or less than 1 mm. Therefore, there is a problem that it is necessary to fix the components after the light receiving is designed so that the lens 2 and the light receiving device 3 are mounted in the package 4, and the positioning of the lens is set.

According to the related example shown in FIG. 4, since the optical system employs two lenses 6 and 7, the distance between the lens 7 and the light receiving device 8 is considerably greater than that in the related example in FIG. 3. However, a complicated assembly process is required to position the two lenses and the light receiving device, to perform tuning for the optical fiber, which is either a set constituted by a plurality of optical fibers or a multicore optical fiber, and to fix all the components.

When the related method employed is the one according to which a butt-joint is used to connect the light receiving device directly to the optical fiber, the light mode pattern of the light output by the optical fiber does not always match the light mode pattern on the incidence side of the light receiving elements. And thus, if the light mode patterns do not match, optical coupling losses will be increased.

When a large, gradient index array is to be employed to condense a plurality of output rays to a plurality of light receiving elements, a reduction in the size of a light receiving module is difficult because of the large size of the gradient index array.

### SUMMARY OF THE INVENTION

The present invention has been made in view of the above circumstances, and provides a light receiving module that is small and can be easily assembled.

In some implementations, a light receiving module of the invention for receiving a plurality of light rays comprises:

a first optical element having a plurality of light emitting sections;

a second optical element having a plurality of light receiving sections; and

a gradient index lens which condenses a plurality of light rays being output from the plurality of light emitting sections to the plurality of light receiving sections respectively, the gradient index lens being disposed between the first optical element and the second optical element.

With this arrangement, the number of components can be reduced, the assembly process is simplified, and downsizing of the light receiving module is enabled.

In the light receiving module of the invention, one end of the first optical element is fixed to a package, and

the gradient index lens and the second optical element are fixed inside the package.

With this arrangement, the number of components can be reduced, the assembly process is simplified, and downsizing of the light receiving module is enabled.

In the light receiving module of the invention, one end of the first optical element is fixed to a package,

the gradient index lens is fixed inside the package, and

the second optical element is fixed inside a hermetic package.

With this arrangement, the number of components can be reduced, the assembly process is simplified, and downsizing of the light receiving module is enabled.

In the light receiving module of the invention, the first optical element is a plurality of optical fibers or a multicore optical fiber having a plurality of cores.

With this arrangement, the number of components can be reduced, the assembly process is simplified, and downsizing of the light receiving module is enabled.

In the light receiving module of the invention, the second optical element is a light receiving device having a plurality of light receiving elements.

With this arrangement, the number of components can be reduced, the assembly process is simplified, and downsizing of the light receiving module is enabled.

According to the present invention, the following effects are obtained.

According to the invention, by employing only a single gradient index lens, a plurality of rays of light input by a plurality of optical fibers are condensed for reception by a plurality of light receiving elements that constitute a light receiving device. Thus, the number of components can be reduced, the assembly process is simplified, and downsizing of the light receiving module is enabled.

### BRIEF DESCRIPTION OF THE DRAWINGS

FIG. 1 is a cross-sectional view of a light receiving module according to one embodiment of the present invention.

FIG. 2 is a cross-sectional view of a light receiving module according to another embodiment of the invention.

FIG. 3 is a cross-sectional view of an example of a related light receiving module.

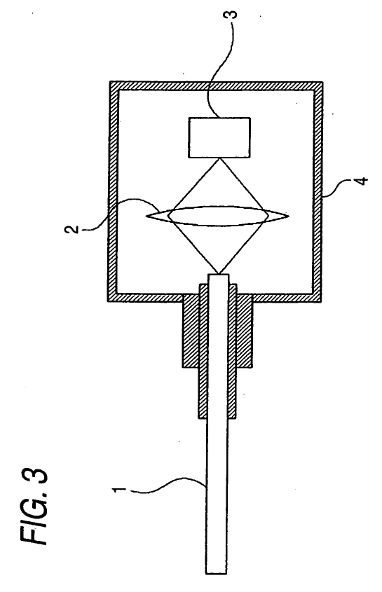

FIG. 4 is a cross-sectional view of another example of the related light receiving module.

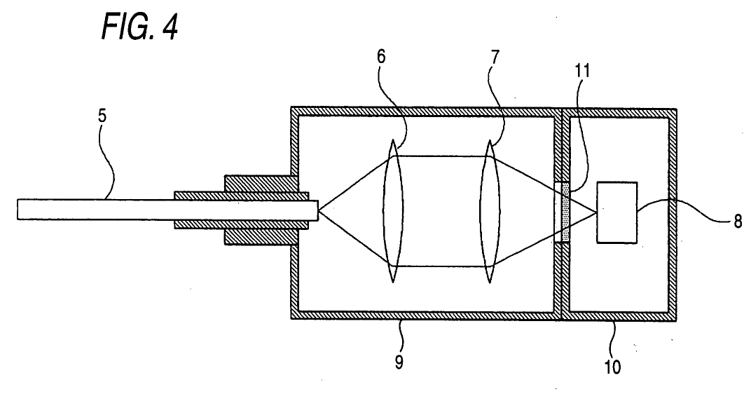

### DESCRIPTION OF THE PRFERRED EMBODIMENTS

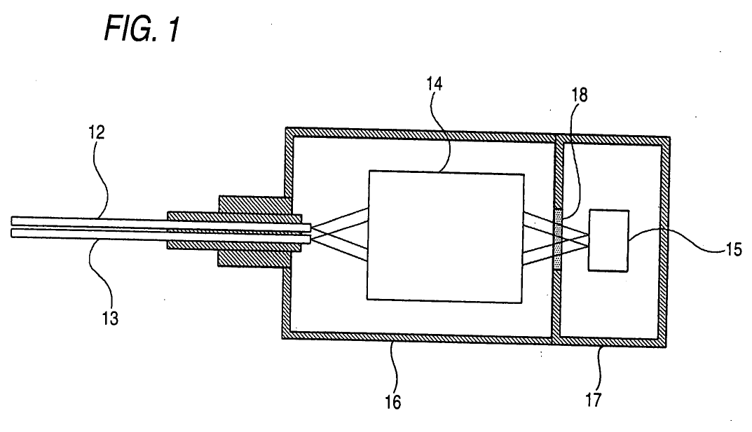

The present invention will now be described in detail while referring to-the drawings. FIG. 1 is a cross-sectional view of a light receiving module according to one embodiment of the present invention.

In FIG. 1, the light receiving module includes: two optical fibers (or a single optical fiber having two cores such as double-core optical fiber) 12 and 13; a gradient index lens 14; a light receiving device 15, constituted by two light receiving elements; a package 16 to which the optical fibers 12 and 13 are to be fixed and in which the gradient index lens 14 is to be mounted; a hermetic package 17, sealed and airtight, in which the light receiving device 15 is to be mounted; and a glass window 18, which is used to provide and maintain an airtight seal for the hermetic package 17, and to introduce light being output by the gradient index lens 14.

One end of the optical fiber 12 and one end of the optical fiber 13 are fixed to the package 16, and the gradient index lens 14 is fixed inside the package 16. Further, the light receiving device 15 is fixed inside the hermetic package 17.

Rays emitted from the ends of the optical fibers 12 and 13 are input to the gradient index lens 14. The rays, condensed by the gradient index lens 14, then pass through the glass window 18, and are collected by two light receiving elements that constitute the light receiving device 15.

As described in “Essentials Of The System Design And Application Of Micro Optical System For Optical Communication”, Kouichi Nishizawa, Electronics Essentials No. 11, Japan Industry Engineering Center, pp. 13-36, 1985, the gradient index lens 14 has the following features.

(1) Flat openings are formed on the incident end and on the emittance end, and light need not be refracted at the openings.

(2) the gradient index lens has small aberration.

(3) The focal distance and the NA (numerical aperture) value are appropriate for the optical fiber.

(4) Since the shape of the gradient index lens 14 is cylindrical, this lens 14 can be mounted directly in a jig such as a V-shaped groove or a pipe, without using a lens holder. Thus, the lens 14 can be mounted and adjusted easily.

Assume that the optical fibers 12 and 13 are formed of a double-core optical fiber, and the light receiving device 15 includes two light receiving elements. Further, assume as follows.

Refractive index of the glass window 18: 1.48

Thickness of the glass window 18: 0.250 mm

Refractive index of the gradient index lens 14 on center axis: 1.590 (wavelength of 1550 nm)

Gradient index profile constant of the gradient index lens 14: 0.1063

Lens pitch of the gradient index lens 14: 0.18

Lens length of the gradient index lens 14: 3.468 mm

Core diameter of the double-core optical fiber: 10 μm

Interval between the core centers of the double-core optical fibers: 250 μm

In this case, spot diameter of the condensed light at the light receiving device 15 is about 8 μm, and the interval between the condensed light spots is about 200 μm.

Further, under these conditions, when the length of the interval between the emittance end surface of the gradient index lens 14 and the glass window 18 is defined as 0.6 mm, and the thickness of the glass window 18 is defined as 0.250 mm, the distance from the glass window 18 to the light receiving device 15 is 1.8 mm to 1.9 mm, and the distance from the emittance end of the double-core optical fiber (the optical fibers 12 and 13) to the incidence end surface of the gradient index lens 14 is 3.64 mm.

These distance, or interval length, measurements appropriately facilitate the mounting of the individual components in a small package.

In addition, when, to provide an appropriate sensitivity, an effective light receiving diameter of the light receiving device 15 is defined as about 10 μm, a cut-off frequency equal to or greater than 40 GHz is available, and ultrafast light receiving module for receiving multiple rays of light can be provided by mounting a light receiving device constituted by a plurality of light receiving elements.

In addition, for the multiple optical signals that are received, photo-electric conversion is performed by a plurality of light receiving elements, and following this, signal processing is performed. Thus, this light receiving module can be applied as an optical signal processing module.

By employing only one gradient index lens 14, a plurality of rays, input by a plurality of optical fibers, are condensed for reception by a plurality of light receiving elements that constitute the light receiving device 15. Thus, the number of components can be reduced, the assembly is simplified, and downsizing is enabled.

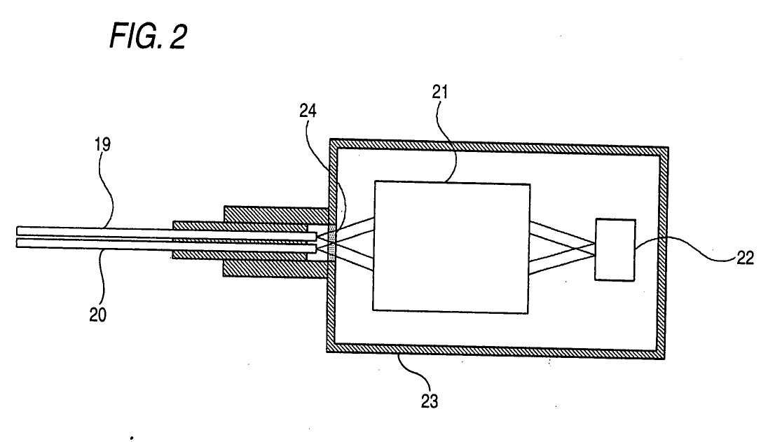

FIG. 2 is a cross-sectional view of a light receiving module according to another embodiment of the invention, wherein a gradient index lens and also a light receiving device is located inside a package.

In FIG. 2, the light receiving module includes: two optical fibers (or a double-core optical fiber) 19 and 20; a single gradient index lens 21; a light receiving device 22, which includes two light receiving elements; and a package 23 to which the optical fibers 19 and 20 are to be fixed, and in which the gradient index lens 21 and the light receiving device 22 are to be mounted.

One end of the optical fiber 19 and one end of the optical fiber 20 are fixed to the package 23, and the gradient index lens 21 and the light receiving device 22 are fixed inside the package 23.

Rays emitted at the ends of the optical fibers 19 and 20 enter the gradient index lens 21 via a glass window 24. The rays are condensed by the gradient index lens 21 and are collected by the two light receiving elements that constitute the light receiving device 22.

As a result, in the embodiment shown in FIG. 2, since all the components can be stored in a small package, further downsizing is enabled.

In the embodiments shown in FIGS. 1 and 2, the light receiving device that includes two optical fibers (or a single double-core optical fiber) and two light receiving elements is specifically shown. However, the structure that can be used for a light receiving device is not limited to the one shown, and the present invention can be applied for a light receiving device that includes an arbitrary number of optical fibers (or an multicore optical fiber formed of an arbitrary number of cores) and an arbitrary number of light receiving elements.

Further, the present invention is not limited to the optical fiber and the light receiving device, and can also be applied for an optical element having a plurality of light emitting sections, or an optical element having a plurality of light receiving sections.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A light receiving module for receiving a plurality of light rays, the light receiving module comprising:
a first optical element having a plurality of light emitting sections;
a second optical element having a plurality of light receiving sections; and
a gradient index lens which condenses a plurality of light rays being output from the plurality of light emitting sections to the plurality of light receiving sections respectively, the gradient index lens being disposed between the first optical element and the second optical element.

2. The light receiving module according to claim 1, wherein one end of the first optical element is fixed to a package, and
the gradient index lens and the second optical element are fixed inside the package.

3. The light receiving module according to claim 1, wherein one end of the first optical element is fixed to a package,
the gradient index lens is fixed inside the package, and
the second optical element is fixed inside a hermetic package.

4. The light receiving module according to claim 1, wherein the first optical element is a plurality of optical fibers or a multicore optical fiber having a plurality of cores.

5. The light receiving module according to claim 1, wherein the second optical element is a light receiving device having a plurality of light receiving elements.
